(19) United States
(12) Patent Application Publication
(10) Pub. No.: US 2015/0127494 A1
(43) Pub. Date: May 7, 2015

(54) REINSTATING ELECTRONIC REQUISITION DEMAND RECORDS

(71) Applicant: Oracle International Corporation, Redwood Shores, CA (US)

(72) Inventors: MAYUKH BHAOWAL, REDWOOD SHORES, CA (US); SUMAN GUHA, FREMONT, CA (US); LEE-HIAN QUEK, FOSTER CITY, CA (US); SHIBHU NAMBIAR, SPRINGFIELD, VA (US); ANGELA XIAN, CUPERTINO, CA (US)

(73) Assignee: ORACLE INTERNATIONAL CORPORATION, REDWOOD SHORES, CA (US)

(21) Appl. No.: 14/071,190

(22) Filed: Nov. 4, 2013

(51) Int. Cl. G06Q 30/06

(52) U.S. Cl. CPC G06Q 30/0635
USPC 705/26.81

(57) ABSTRACT

A method of reinstating requisition demands using information from a canceled purchase order in an enterprise accounting computer system may include identifying canceled purchase order distributions in the canceled purchase order. The method may also include generating new requisition distributions based on the canceled purchase order distributions, and generating new requisition lines for the new requisition distributions. The method may further include generating one or more new purchase orders based on the new requisition lines.

### BACKGROUND

When an organization makes a purchase, many different departments and software systems within the organization may be involved. A purchase may begin as a request from a requesting department, and eventually result in a purchase order. Purchase orders may be contractually binding documents between a buying organization and a selling organization. After the creation of a purchase order, the subsequent events in the purchase order's lifecycle may include delivering, receiving, and invoicing activities. For instance, an order for goods may be shipped by a supplier, and then received and delivered to a requester within an organization. The supplier may send an invoice for the order, and an accountant may enter the invoice into a computer system in an accounts payable department of the buying organization.

A buyer, who represents the buying organization within a purchasing department, may have the authority to change the status of a purchase order such that no more receiving or invoicing associated with the purchase order can occur. Such a status is known as “final close.” This status may comprehensively prevent modifications to, or actions against, a purchase order. This may mean that one cannot perform actions against a purchase order that has been final closed, such as receipt, transfer, inspect, deliver, correct receipt quantities, invoice, return to supplier, or return to receiving. Additionally, a purchase order may be final closed when an accounts payable accountant enters an invoice in the system and “final matches” that invoice to the purchase order. If the accountant does not expect any more invoices to be matched with the purchase order, the accountant has the option to “final match” the invoice to the purchase order. This may automatically cause a final close of the purchase order. Purchase orders sent from requesting organizations are expected to be fulfilled regardless of any complications between a purchasing department and a supplier.

### BRIEF SUMMARY

In some embodiments, a method of reinstating requisition demands using information from a canceled purchase order in an enterprise accounting computer system may be presented. The method may include identifying canceled purchase order distributions in the canceled purchase order. The method may also include generating new requisition distributions based on the canceled purchase order distributions. The method may additionally include generating new requisition lines for the new requisition distributions. The method may further include generating one or more new purchase orders based on the new requisition lines.

In some implementations, the method may also include copying information from original requisition lines into the new requisition lines. The method may additionally include computing new requisition quantities for the new requisition distributions based on canceled distribution quantities in the canceled purchase order distributions, and/or computing new requisition costs for the new requisition distributions based on canceled distribution costs in the canceled purchase order distributions. The method may further include inserting the new requisition lines into an original requisition. The new requisition lines may be inserted into the original requisition as children of corresponding original requisition lines. The information from the original requisition lines may include a designation of a product or service being purchased. Generating the new requisition distributions based on the canceled purchase order distributions may include copying billing and delivery information from the canceled purchase order distributions to the new requisition distributions. Identifying canceled purchase order distributions in the canceled purchase order may include identifying canceled purchase order distributions that have not been invoiced. The canceled purchase order distributions may have changed since the canceled purchase order was generated such that the canceled purchase order distributions are not the same as original requisition distributions.

In some embodiments, a computer-readable memory may be presented. The computer-readable memory may comprise a sequence of instructions which, when executed by one or more processors, causes the one or more processors to reinstate requisition demands using information from a canceled purchase order in an enterprise accounting computer system. The instructions may cause the processor(s) to identify canceled purchase order distributions in the canceled purchase order, generate new requisition distributions based on the canceled purchase order distributions, generate new requisition lines for the new requisition distributions, and generate one or more new purchase orders based on the new requisition lines.

In some embodiments, a system may be presented. The system may include one or more processors and a memory communicatively coupled with and readable by the one or more processors. The memory may comprise a sequence of instructions which, when executed by the one or more processors, cause the one or more processors to reinstate requisition demands using information from a canceled purchase order in an enterprise accounting computer system. The instructions may cause the processor(s) to identify canceled purchase order distributions in the canceled purchase order, generate new requisition distributions based on the canceled purchase order distributions, generate new requisition lines for the new requisition distributions, and generate one or more new purchase orders based on the new requisition lines.

### BRIEF DESCRIPTION OF THE DRAWINGS

A further understanding of the nature and advantages of the present invention may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates a block diagram of components of an exemplary operating environment in which various embodiments of the present invention may be implemented.

FIG. 2 illustrates a block diagram of an exemplary computer system in which embodiments of the present invention may be implemented.

FIG. 3 illustrates a flow diagram of a requisition and purchase order process in a business organization, according to one embodiment.

FIG. 4 illustrates a diagram of a requisition, according to some embodiments

FIG. 5 illustrates a diagram of a purchase order, according to some embodiments.

FIG. 6 illustrates a relational diagram of how distributions and lines are related between requisitions and purchase orders, according to some embodiments.

FIG. 7 illustrates a flowchart of a method for reinstating line items from the canceled purchase order, according to some embodiments.

FIG. 8 illustrates a flowchart of a method for reinstating canceled purchase order distributions, according to some embodiments.

FIG. 9 illustrates a block diagram for updating a requisition from a canceled purchase order, according to some embodiments.

FIG. 10 illustrates a block diagram for creating a new purchase order from a requisition, according to some embodiments.

### DETAILED DESCRIPTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “ machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

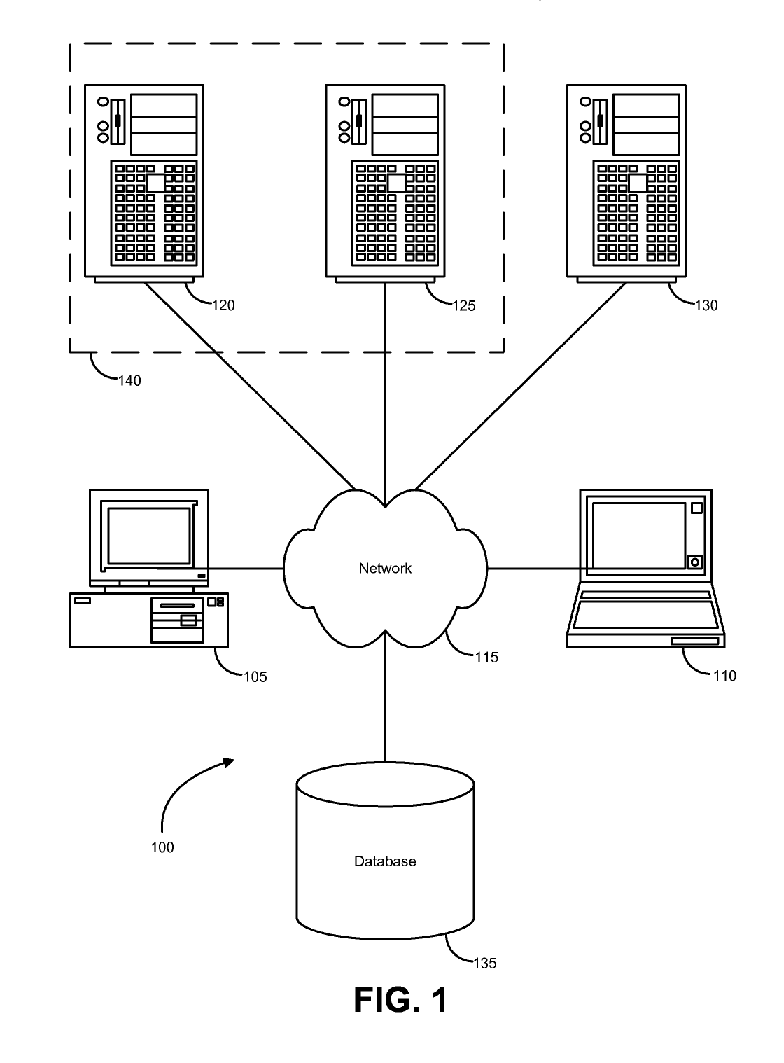

Each of the embodiments disclosed herein may be implemented in a general-purpose computer system. FIG. 1 is a block diagram illustrating components of an exemplary operating environment in which various embodiments of the present invention may be implemented. The system 100 can include one or more user computers 105, 110, which may be used to operate a client, whether a dedicated application, web browser, etc. The user computers 105, 110 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network may can be any type of network familiar to those skilled in the art that can support data communications using any of a variety of commercially-available protocols, including without limitation TCP/IP, SNA, IPX, AppleTalk, and the like. Merely by way of example, the network 115 may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10g, that is adapted to store, update, and retrieve data in response to SQL-formatted commands.

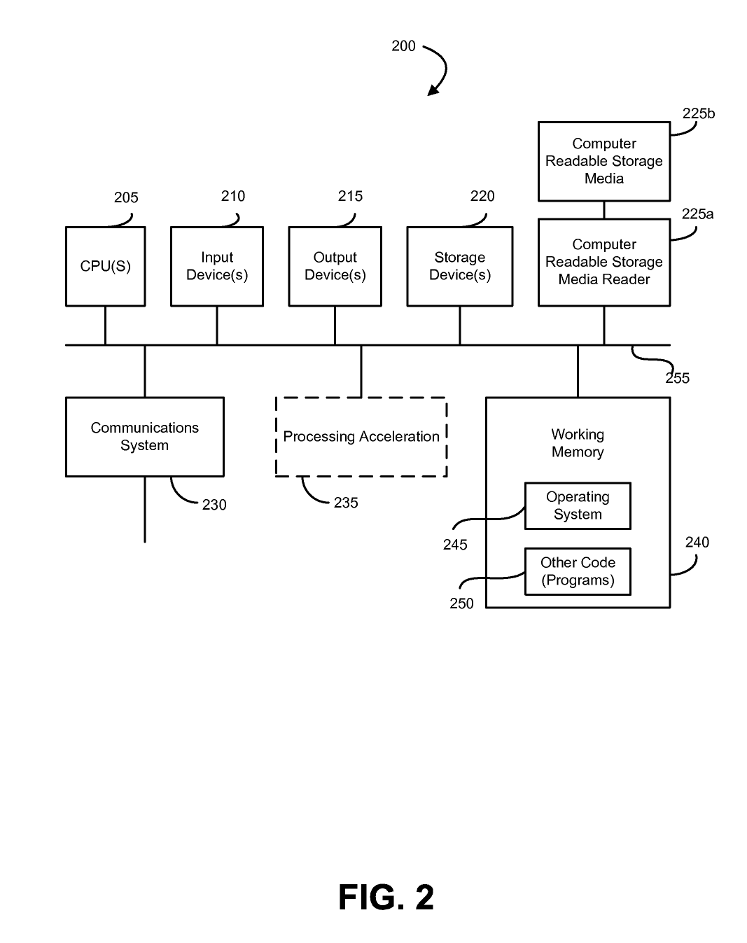

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

Each of the methods described herein may be implemented by a computer system, such as computer system 200 in FIG. 2. Each step of these methods may be executed automatically by the computer system, and/or may be provided with inputs/outputs involving a user. For example, a user may provide inputs for each step in a method, and each of these inputs may be in response to a specific output requesting such an input, wherein the output is generated by the computer system. Each input may be received in response to a corresponding requesting output. Furthermore, inputs may be received from a user, from another computer system as a data stream, retrieved from a memory location, retrieved over a network, requested from a web service, and/or the like. Likewise, outputs may be provided to a user, to another computer system as a data stream, saved in a memory location, sent over a network, provided to a web service, and/or the like. In short, each step of the methods described herein may be performed by a computer system, and may involve any number of inputs, outputs, and/or requests to and from the computer system which may or may not involve a user. Those steps not involving a user may be said to be performed by the computed without human intervention. Therefore, it will be understood in light of this disclosure, that each step and each method described herein may be altered to include an input and output to and from a user, or may be done automatically by a computer system. Furthermore, some embodiments of each of the methods described herein may be implemented as a set of instructions stored on a tangible, non-transitory storage medium to form a tangible software product.

Described herein, are embodiments for reinstating distributions from canceled purchase orders. When a purchase order is canceled, unfulfilled distributions may be identified and used to create new requisition distributions that are encapsulated in new requisition lines. Up-to-date information that was represented in the canceled purchase order distributions can be preserved and used in the new requisition distributions. Additional information may be retrieved from the purchase order lines and/or their original requisition lines. Canceled purchase order distributions and/or purchase order lines can be linked to original requisition lines and distributions by references that have been inserted at the time the purchase order was created. The new requisition lines can be inserted as children in the original requisition, which then can be processed to generate new purchase orders in order to fulfill the canceled distributions. For systems of budgetary controls and/or encumbrance accounting procedures, new budget allocations can be committed that match the canceled distribution amounts.

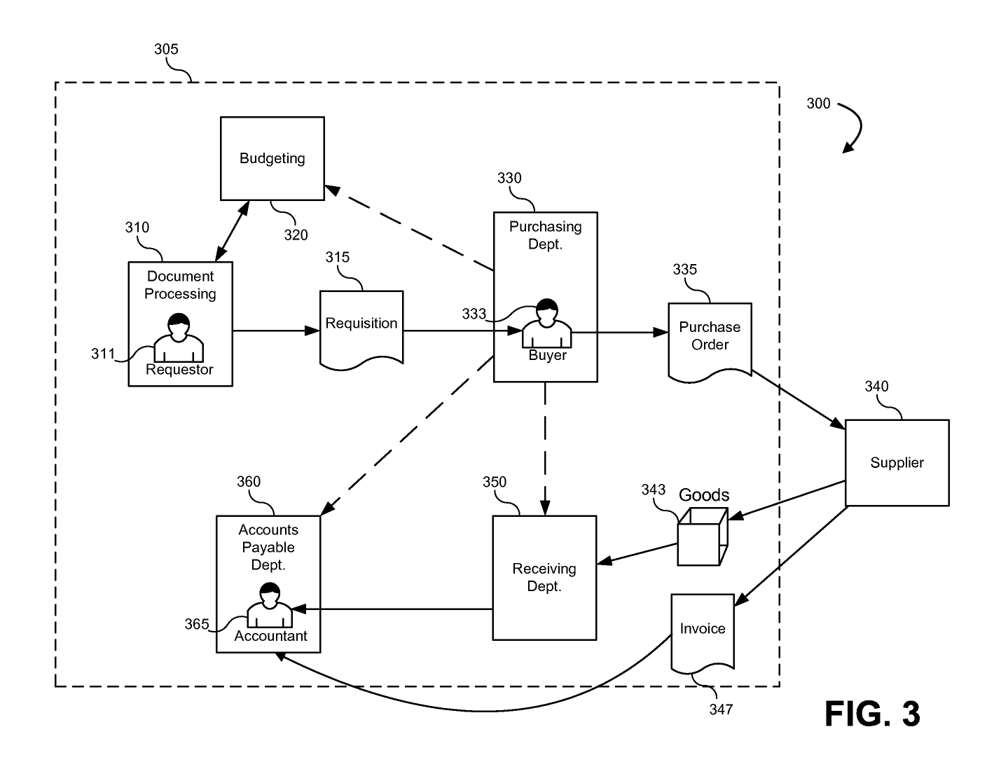

FIG. 3 illustrates a flow diagram 300 of a requisition and purchase order process in a business organization, according to one embodiment. The process may begin with a requester 311 in an organization 305 attempting to make a purchase. For example, a member of a document-processing department may attempt to purchase a new copy machine, which may include machine itself along with periodic shipments of toner and other service and maintenance agreements. The organization 305 may operate under a budget and require that any purchases be approved by a budgetary authority and/or budgeting department 320. If a budgetary control system is in operation, then the budgeting department 320 may accept or reject the purchase based on the current budget and/or known future expenditures.

In addition to budgetary approval, the organization may also use encumbrance accounting procedures. In this case, a first allocation of the budget may be made to correspond to an initial budgetary allocation associated with an expected cost of the requested purchase, along with any other costs required by the encumbrance accounting process. This first allocation of the budget may be recorded as an encumbrance journal entry in the purchasing sub-ledger. The purchasing sub-ledger may be separate from the general accounting ledger, and may be periodically incorporated into the general accounting ledger.

Once the budgeting department 320 clears the requisition and funds for it are reserved in the budgetary control system as well as corresponding encumbrance accounting system, the requisition 315 may be routed to a buyer 333 in the purchasing department 330. The buyer may analyze the requisition 315 and determine when, where, and how the corresponding purchase may be made. For example, the buyer 330 may use special corporate contracts for a reduced price on the purchase, or the buyer 330 may use special corporate accounts that provide discounts and/or benefits to the organization. The buyer 330 may generally use any corporate resources available to achieve an optimal price and/or service agreement with a supplier 340.

The buyer 333 may use the requisition 315 to create a purchase order 335. In one embodiment, a purchase order may represent a legal contract between the organization 305 and a supplier 340. The purchasing department 330 may insert provisions or clauses into the purchase order 335 that dictate the legal terms and conditions of the purchase and allow the purchasing department 332 to enable downstream acceptance, invoicing, and/or other operations to continue.

The purchase order 335 may be sent to the supplier 340, who under the general rules of contract law, may accept or reject the purchase order 335. Upon acceptance, the supplier 340 may send the goods 343 to a receiving department 350 of the organization 305. The supplier 340 may also deliver the goods 343 ordered and send an invoice 347 to the organization 305. The goods 343 may be received by the receiving department 350, and invoice 347 may be received by accounts payable department 360. An accountant 365 within the accounts payable department 360 may accept the invoice 347, and match it to the purchase order 335. If the purchase order 335 represents a single delivery/performance, then the accountant 365 may determine a “final match” between the invoice 347, and the purchase order 335. This final match may have the effect of a final close on the purchase order 335.

Alternatively or additionally, if the purchase order 335 represents more than a single delivery/performance, then the invoice 347 may be matched to the purchase order 335 without being final, i.e. closing the purchase order 335. Thus, in cases where future deliveries on the purchase order 335 are expected, or where future invoices may be matched to the purchase order 335, the purchase order 335 may be left open in order to match those future deliveries/invoices.

In some embodiments, the buyer 333 in the purchasing department 330 may determine that the purchase order 335 should be finally closed. This may occur in cases where the accountant 365 in the accounts payable department 360 failed to correctly final match the invoice 347 to the purchase order 335. Also, the buyer 333 may determine that any future deliveries and/or performances specified in the purchase order 335 may no longer be necessary. For example, the purchase may be for a new copier that includes future deliveries of toner and a service schedule. However, if the copier is outdated and removed from operation, of if the organization 305 sold the copier, then the buyer 333 may final close the purchase order 335 to prevent future deliveries of toner and the future performance of service on the copier. In one embodiment, a final close in the purchasing department 330 may be accompanied by an indication of the final close sent to the receiving department 350 and/or the accounts payable department 360 requesting that they stop processing transactions on the purchase order. Other departments may also be sent a similar indication.

Consequently, a final close may occur in at least two situations: the first in the purchasing department 330, and the second with a final match in the accounts payable department 360. During such a final closure, any remaining funds allocated to this purchase order may be liquidated. In addition, an encumbrance accounting event may be raised to correct any encumbrance accounting entries generated during purchase order creation. However, the purchasing department 330 often may not be aware of circumstances that may require the purchase order 335 to undergo a final close (such as the selling of the copier described above). Similarly, the accounts payable department 360 may often fail to correctly determine that the match between the invoice 347 and the purchase order 335 should be final. In both cases, the finality of the final close action may be delayed indefinitely because either department may be reluctant to prematurely final close the purchase order 335.

Occasionally, situations may arise in which a purchase order may need to be canceled, such as the buying company is not satisfied with the quality of the goods or services being provided by the selling company, or selling company has to incur substantial loss to fulfill the order.

Described herein are embodiments for reinstating a canceled purchase order. As described above, purchase requisitions are formal requests created by internal organizations that are sent to a purchasing department to procure goods or services. A requisition may include one or more requisition lines. Typically, a requisition line may include a description, a quantity of goods or services to be purchased, a make or model of goods, a desired delivery date, a cost center, an amount of money that a purchasing organization is authorized to spend on the goods or services, and/or the like. The purchasing department can then transform the requisition lines into one or more purchase orders.

At the purchasing department, each requisition line can be sourced to a matching supplier via legally binding contract between the procuring organization represented by the buyers and the supplying organizations represented by suppliers or vendors. As described above, these legally binding contracts are referred to as purchase orders. Generally, suppliers provide the purchaser with goods or services based on the purchase order as a contract. Subsequent to the issuance of a purchase order, goods and/or services to be procured are shipped by the supplier and eventually received, delivered, invoiced, and billed to the procuring organizations.

In many cases that involve supply chain systems or indirect procurement systems, there can be multiple receipts, multiple deliveries, and multiple bills for various portions of a particular purchase order that are spread out on a varying timeline. Goods may be received, bills may be sent, and payment may be received over the varying time line until the purchase order is fulfilled. In some cases, purchase orders may be ongoing and involve periodic shipments without a specified end date.

However, occasionally inventory shortages at the supplier's end can lead to cancellation of a purchase order at any point in the lifecycle timeline of the purchase order. This can lead to instances where the initial demand is only partially fulfilled, or in some cases not fulfilled all. By way of example, a supplier may run low on a supply of printer toner cartridges, and may be unable to fulfill the complete order in a timely fashion. In other examples, a supplier may discontinue production of a particular item, go out of business, relocate, or become a subsidiary of another entity. In each of these cases, the supplier may be forced to cancel delivery of contracted purchase order items before the entire purchase order is fulfilled. From a contractual standpoint, many purchase orders will include conditions under which a purchase order may be canceled by the supplier. Therefore, even though the supplier will often not face legal action for not fulfilling a purchase order, the procuring organization often still needs the goods that were under contract. Therefore the unfulfilled demand still needs to be met and sourced through a different supplier.

Prior to this disclosure, a new purchase order had to be created based on the original requisition lines that were sent to the procuring organization and recreated by the requesting department. However, it is common that certain attributes of the requisition line change over time as the related purchase order is fulfilled. For example, the supplier may inform the purchasing department that system upgrades have occurred, and thus a different type of product may be needed going forward. In another example, quantities of items may change over time, as well as needed delivery dates, prices, brands, models, makes, features, versions, and/or any other characteristic of a purchased service or product. These changes are typically not reflected in the original requisition lines. Instead, these changes are made directly to the purchase order that resulted from the requisition lines.

Generally, every requisition demand initially carries business attributes, such as billing and delivery information, for each of their distributions. Requisition lines may include (among other things) a charge account that describes a particular cost center that should bear the cost of the item. Requisition lines may also include a delivery location where the item should be delivered or the service should be performed. A requisition line may also include a request or may specify a person, department, or an inventory planning/replacement driven supply chain system responsible for ordering the product/service. The information in the requisition line represents the initial state of the process of planning for demand.

However, as stated above, once the requisition is sourced to a supplier and associated with a legal purchase order, the information regarding billing and delivery gets updated in the purchase order to depict a more accurate picture of the relationship between the supplier and the purchasing department. Businesses generally evolve, cost centers realign, people and facilities move, and budgets readjust. All of these impact open business transactions represented by purchase orders, which are then appropriately updated to keep pace with these changes.

After changes are continuously made to a purchase order, a purchase order may be canceled for various reasons, such as a deficit in supply, and a purchase order cancellation may be initiated by the supplier or the purchaser. The purchasing department may take measures to satisfy the unfilled demand of the purchase order. The original demand is represented by the requisition. Prior to this disclosure, when a supplier or a buyer initiates cancellation of a purchase order, the unfulfilled part of requester's demand was reinstated by creating a new requisition by copying the attributes from the original requisition line. Since the attributes of the original requisition are the same as they were originally entered by the requester (or were automatically generated by an inventory planning system), such an approach discards the changes that may have occurred in the purchase order that is being canceled. By relying exclusively on the original requisition lines, the latest accounting information, project details, need-by date, and/or the like, represented on the purchase order would be lost.

Embodiments described herein may reinstate a canceled purchase order using information from the canceled purchase order. This information is independent of the supply end of the purchasing agreement, and cancellation the purchase order due to supplier-side deficits do not invalidate the value of these attributes. Although it was previously believed that it was best to start over, it has been discovered that discarding this information and rolling back to a previous state represented by the requisition led to a loss of both historical information regarding the transaction, as well as the latest desires of the requesting department. As mentioned above, quantities, costs, brands, and/or any other attributes of the desired product or service may change based on the desires of the requesting department and/or the purchasing department. The embodiments discussed herein capture this valuable information by using it to reinstate requisition demands when canceling a purchase order.

An equally important aspect of reinstating a canceled purchase order involves financial and budgetary concerns. Many organizations, especially federal, public sector, and quasi-public sector organizations may implement budgetary controls and/or encumbrance accounting into their business processes. For organizations with budgetary controls for their transactions, the amount on the original purchase order is treated as an obligation or encumbrance. In other words, funds must be adequately reserved for the purchase items before the purchases are fulfilled by the supplier. When a purchase order is canceled and the remaining demand is reinstated in the form of requisitions, the outstanding obligation for the purchase order is preserved in the form of new requisition commitments. This facilitates the funds to be consumed by other purchase orders however, if while reinstating the requisition demand, the application discards the charge account, quantity, cost, and/or any other information on the purchase order, the funds reinstated would be out of sync with what is required to source the demand to a new supplier. This can lead to a budget deficit and loss of funds which were already secured by the requesting organization.

By way of example, the original requisition may have set aside a cost of $10,000 to be sourced from account A for a particular purchase. However, during the fulfilling of the purchase order, the requesting organization or the purchasing department may change the distribution to charge a cost of $8,000 to account B. The change to the purchase order would be reflected in the budgetary controls and encumbrance accounting systems to properly reflect the true cost of the product/service. However, when the purchase order is canceled, the purchase order would be reinstated with the $10,000 cost charged to account A. This can result in a perceived lack of funds available to the organization, as well as incorrect financial accounting statements that can have legal ramifications.

It should be noted that at least three different entities can change distributions and line items in a purchase order. Turning back to FIG. 3, the requester 311 can request the changes be made based on the needs of the requesting department 310. A buyer 333 may make changes based on benefits provided to the purchasing department 330, such as new vendor contracts, new discounts available, and/or the like. Additionally, the supplier 340 may request the changes be made to the purchase order in order to accommodate supply-side business needs. In some embodiments, the supplier 340 may be provided with a portal that allows them to view, edit, update, change, and otherwise manipulate the purchase order 335 subject to approval of the purchasing department 330.

In the embodiments described herein, the updated business attributes on the purchase order can be preserved in the event of a cancellation of a purchase order that requires reinstatement of requisition demands. Instead of discarding the current value of these attributes and using the old requisition attributes, these embodiments can fill in the new requisition lines with the canceled purchase order information, and then fill in any missing information with the original requisition information. This can eliminate the need for the buyer to manually edit a requisition to reflect the latest attributes on the purchase order. Some embodiments may also apply this method to new purchase orders when a residual requisition demand is sourced again. In other words, a requisition that is repeatedly submitted to the purchasing department 330 may be sourced using purchase order information based on a previous requisition and purchase order pairing. Instead of starting from scratch, the purchase order can be created using information from a previous purchase order (supplier, shipping information, etc.) with any remaining information being provided by the latest requisition.

Many legacy purchasing systems only allowed cancellation of a purchase order if no part of the purchase order had been received, delivered, invoice, and/or billed. The embodiments described herein provide the flexibility needed to cancel and reinstate purchase order line items at any point during the procurement process. Additionally, by using the latest cost and quantity and accounting information from the canceled purchase order, budgetary controls and/or encumbrance accounting organizations can be provided with accurate financial information and cost estimates.

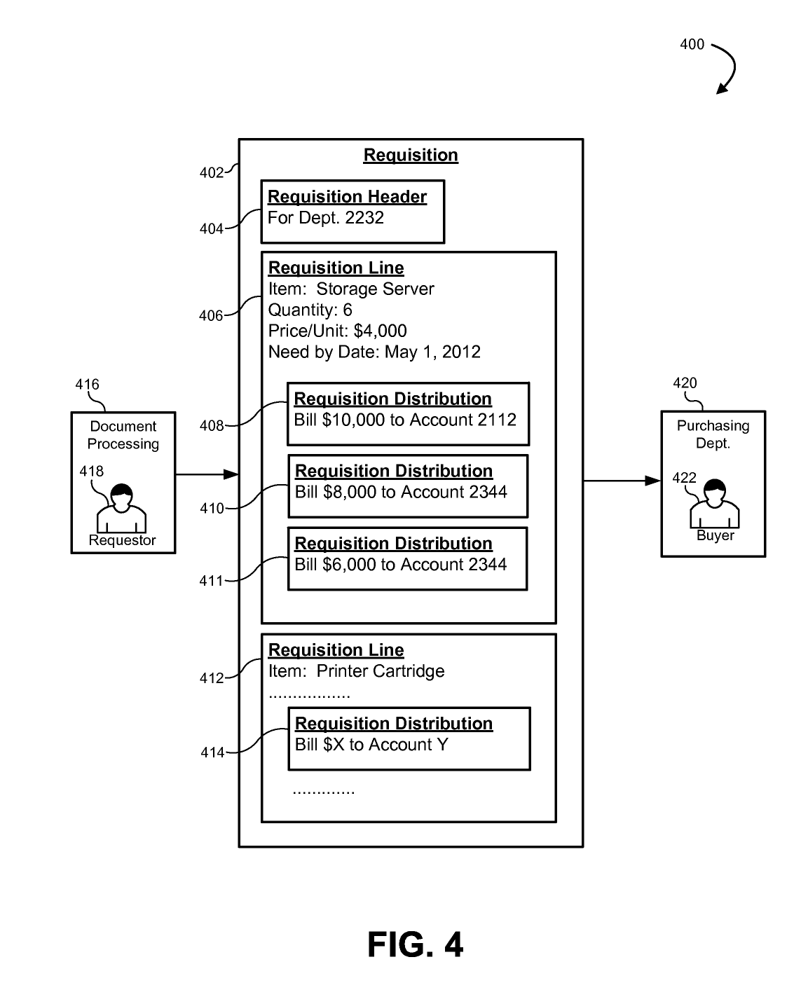

Before describing particular methods and systems in detail, exemplary requisitions and purchase orders will be presented that may be further referred to herein. FIG. 4 illustrates a diagram 400 of a requisition 402, according to some embodiments. The requisition 402 includes a requisition header 404. The requisition header may include information such as a requesting party, a requesting department, and/or other information that identifies details that apply to the entire requisition. The requisition 402 may also include one or more requisition lines 406, 412.

Requisition lines 406, 412 represent the items that need to be procured, along with the quantity, approved budget amount, and/or deliver information. Additionally, requisition lines 406, 412 may also include deliver-to locations, need-by dates, and other information that specifies time and place requirements. Finally, each requisition line 406, 412 may include one or more requisition distributions 408, 410, 411, 414 that cover billing information such as account codes, cost centers, and authorized purchasing amounts.

Generally, a single requisition may have a header, and one or more requisition lines. Similarly, each requisition line may include one or more distributions. For example, a single requisition may include multiple products (items) being ordered by a single department, while each line item may include multiple requisition distributions. This allows the cost of single items to be split between multiple accounts. As described above, the requisition 402 is generally provided by a requester 418 from a requesting department 416. The requisition 402 is provided to a buyer 422 in a purchasing department 420. The buyer 422 then processes the requisition 402 along with other requisitions to generate one or more purchase orders.

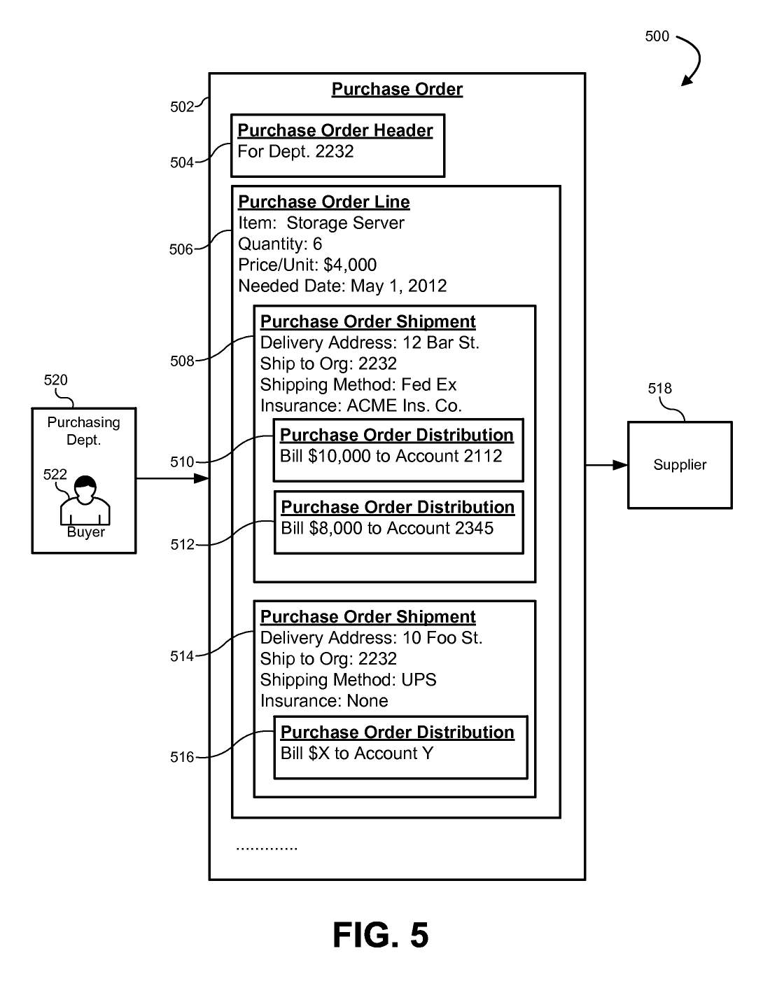

FIG. 5 illustrates a diagram 500 of a purchase order 502, according to some embodiments. Purchase order 502 may be generated from the requisition 402 of FIG. 4. It should be noted that there is not necessarily a one-to-one relationship between a purchase order and a requisition. Line items from multiple requisitions can be combined into a single purchase order. For example, if multiple departments order toner cartridges, requisition lines can be from multiple requisitions from multiple departments and can be combined into a single purchase order for a single supplier of toner cartridges. Additionally, a single requisition may be split between multiple purchase orders. For example, a single requisition may include orders for toner cartridges and pencils. Each of these two requisition line items would typically be sourced from different suppliers, each needing their own purchase order.

Generally, each purchase order 502 will have a purchase order header 504 that includes supplier-specific information, such as a supplier name, address, account code, and/or the like. The purchase order 502 may have a structure that is similar to a requisition such that it includes line items in distributions in the form a purchase order lines 506 and purchase order distributions 510, 512, 516. However, the purchase order 502 may also include purchase order shipments 508, 514. Generally, the purchase order lines 506 and the purchase order distributions 510 will carry the same or similar information is included in the requisition lines and requisition distributions respectively. The shipments are introduced to carry detailed information on the various shipments that need to be fulfilled, and will generally include a ship-to location, a ship-to organization, a shipping method, insurance and carrier information, and/or other shipping/receiving controls.

In the example of FIG. 5, the purchase order 502 includes a purchase order line 506 for six storage servers. Because the purchase order 502 may be created based on multiple requisitions from multiple departments, the storage servers may be grouped together for discount pricing. However, the purchase order line 506 for all six storage servers may be split between two shipments 508, 514 such that the orders from each requisition can be shipped to the requesting department. The shipment to a single location may also be split between different cost center accounts represented by separate purchase order distributions 510, 512. The purchase order 502 can then be sent to the supplier 518, who will in turn ship the goods to the location(s) specified by the purchase order shipments 508, 514.

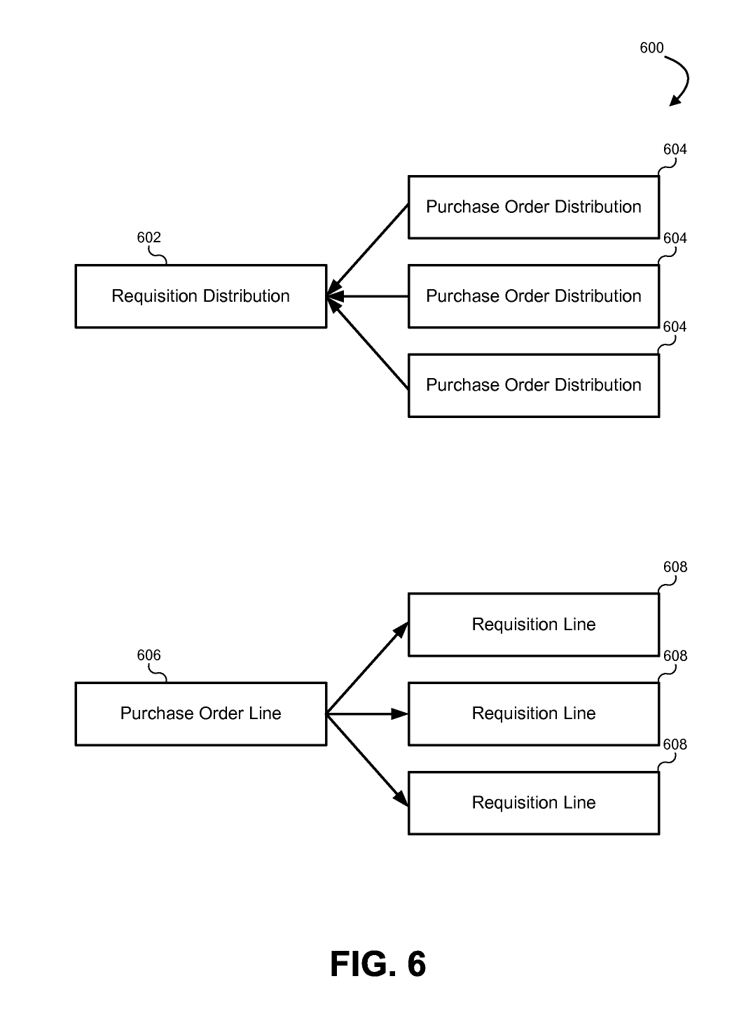

Although not shown explicitly in the example of FIG. 5, each purchase order in the embodiments described herein may carry a reference to original requisition lines from which the purchase order originated. This reference can be maintained at the purchase order line level (506) and alternatively or additionally at the distribution level (510, 512, 506). FIG. 6 illustrates a relational diagram 600 of how distributions and lines are related between requisitions and purchase orders, according to some embodiments. A requisition distribution 602 can have a one-to-many relationship with purchase order distributions 604. For instance, the requisition for a dozen storage servers can be charged to account A. When the purchase order is created, the purchase order distribution will carry a reference back to the requisition distribution 602. As will often happen, the buyer can split the purchase order distribution into multiple purchase order distributions 604 such that the quantity of the original distribution can be split between, for example, account A, account B, and account C. This split may occur in order to bill or deliver items purchased from the same supplier separately. In this case, all of the purchase order distributions 604 will carry the same reference to the requisition distribution, thus making the relationship one-to-many.

Similarly, a single purchase order line 606 may carry a reference to multiple requisition lines 608. As described above, a buyer in a purchasing department may combine items from multiple requisitions in order to take advantage of special purchasing relationships, bulk discounts, and/or the like. Therefore, a purchase order line may store multiple references to multiple requisition lines 608. These references between the purchase order and the requisition may be used to re-create a new requisition line after a purchase order has been canceled as described below.

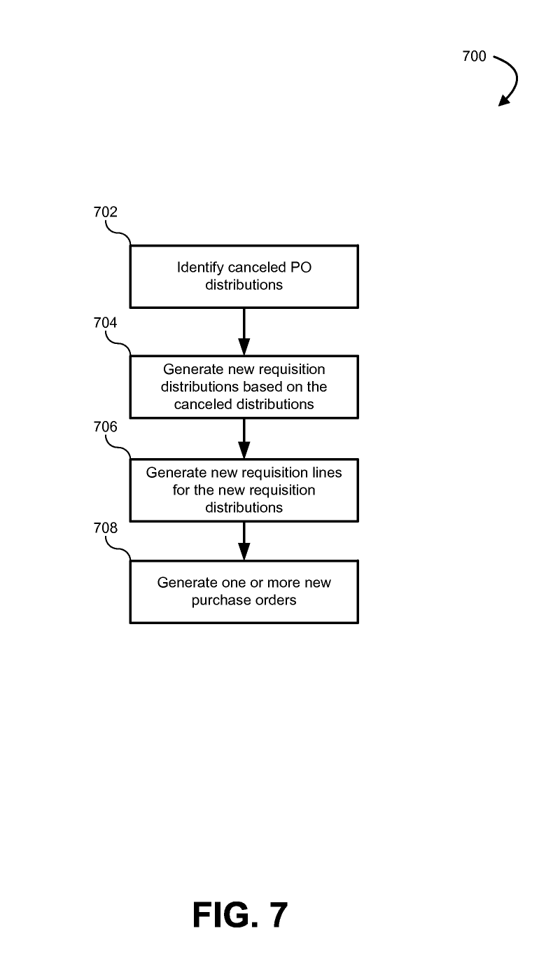

FIG. 7 illustrates a flowchart 700 of a method for reinstating line items from a canceled purchase order, according to some embodiments. The purchase order may be canceled for many reasons, including a stock shortage at the supplier's end, a supplier going out of business, a product line being discontinued, and/or the like. The method may first include identifying canceled purchase order distributions (702). In some embodiments, this may include identifying any purchase order distributions with the canceled amount greater than zero. This may include accounting for orders that have been invoiced, received, delivered, and/or billed. For example, one embodiment may to determine the canceled amount as [(ordered amount on the distribution)−max(invoiced, received, delivered, build)] amount. As described above, a single purchase order may include many different distributions that involve different line items and different shipments. Any of these may be canceled on a purchase order. Also, some embodiments may allow for the analysis of multiple purchase orders from different suppliers. For example, the purchasing department may order server racks from three different suppliers, two of which cancel the purchase orders. These may be analyzed together in order to reinstate canceled purchase order distributions from multiple purchase orders.

The method may additionally include generating new requisition distributions based on the canceled distributions from the purchase order (704). In some embodiments, requisition distribution information such as billing and delivery information can be copied directly from the canceled purchase order distributions. This provides a means whereby the newly generated requisition distributions maintain the most up-to-date information as recorded in the purchase order distributions that were canceled. Some embodiments may also identify a canceled quantity in the purchase order distribution and record the canceled quantity as the requested quantity in the requisition distribution. Additionally, some embodiments may also identify the canceled cost in the purchase order distribution and record the canceled cost as the requested cost in the requisition distribution. Using the cost numbers from the purchase order distribution instead of the original requisition distribution may be instrumental in allowing encumbrance accounting and budgetary controls to accurately record the cost of a transaction.

The method may further include generating new requisition lines for the new requisition distributions (706). The new requisition lines may include information from the original requisitions. In these embodiments, the reinstated purchase order may include relevant information that is subject to change throughout the purchasing process from the purchase order distributions. On the other hand, any information that is likely to stay static throughout the purchasing process can simply be copied from the original requisition lines. This may include an item type, a delivery address, and/or the like.

Method may additionally include generating one or more new purchase orders (708). By generating new requisition lines, the requisition lines can simply be fed into an existing purchasing department system. Purchasing department systems may already be designed to receive requisition lines and present them to buyers in order to generate purchase orders. Therefore, the purchasing department may receive these requisition lines without requiring any special procedures to reinstate the canceled purchase order distributions.

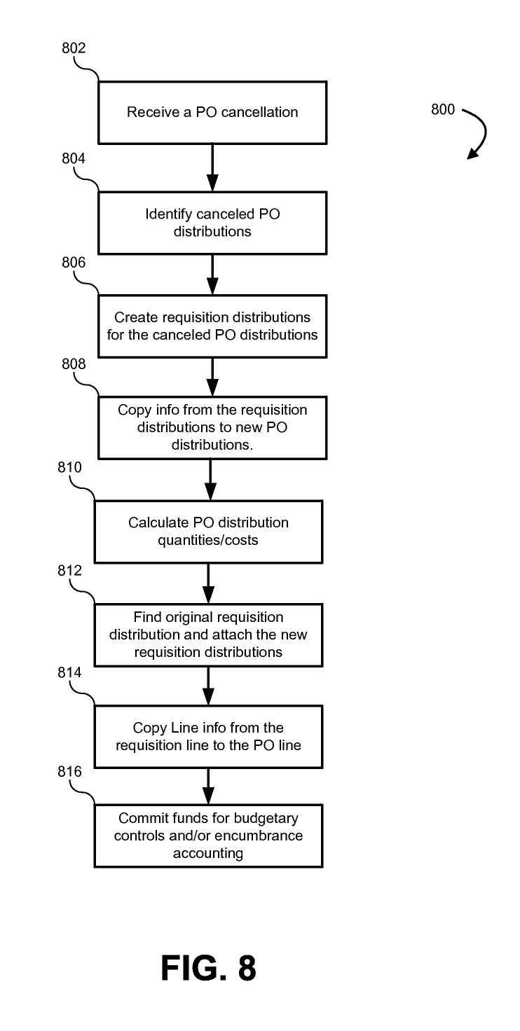

FIG. 8 illustrates a flowchart 800 of a method for reinstating canceled purchase order distributions, according to some embodiments. Flowchart 800 may represent a method that includes a specific implementation of the general method described in flowchart 700. The method may include receiving a purchase order cancellation (802). The purchase order cancellation may be received through a portal linked to a supplier that is integrated with the purchasing department computer system. Alternatively, the purchase order cancellation may also be received via e-mail or any other means of communication between the supplier and the purchasing department. The method may also include identifying canceled purchase order distributions (804) and creating requisition distributions from the canceled purchase order distributions (806). These operations may be carried out as described above.

The method may further include copying information from the requisition distributions to the new purchase order distributions (808). This may include identifying information that has not changed between the original requisition distributions and the canceled purchase order distributions. In some embodiments, information may have changed, but it may be determined that the information was changed because of requirements specific to a supplier. If the supplier has canceled the purchase order and a new suppliers being chosen, this information may be reinstated from the original requisition lines rather than the canceled purchase order lines. As described above, the method may additionally include calculating purchase order distribution quantities and/or costs based on the canceled purchase order distributions (810).

Instead of creating a new requisition, some embodiments may reuse the original requisition and simply add the new requisition lines with their encapsulated requisition distributions as additional elements of the original requisition. This may allow the original requisition to reuse the same header, requisition number, and/or the like. This may also allow the requesting department to see a historical list of changes to the requisition over time, and thus recognize a canceled purchase order situation and the automatic adjustments made to remedy the cancelation.

In order to attach the new requisition lines to the original requisition, the method may include finding the original requisition distribution and attaching the new requisition distributions (812). For each canceled purchase order distribution, a reference may be stored therein that can be used to identify the original requisition distribution. The purchase order line can also reference the original requisition line. In some embodiments, the new requisition line can be placed as a child of the original requisition line in the original requisition. This hierarchical nature of appending new requisition lines to original requisitions means that multiple orders can be canceled in an original requisition and each new requisition line added to reinstate the canceled distributions can simply be added as children to the original requisition lines. This allows customers to view requisitions as they were originally submitted, and allows the new requisition lines to reuse information from the original requisitions, such as the requisition header information.

In order to facilitate adding new requisition lines as children of existing requisition lines, the method may also include adding references to each purchase order distribution and purchase order line as they are created from the requisition (814). These references are described above. After dereferencing the reference in the purchase order line/distribution, the method may include copying requisition line information into the new requisition line. The requisition line information may be copied from the original requisition line, or from the original purchase order line, as the purchase order line and requisition line will often include identical information.

Additionally, the method may include committing funds for budgetary controls and/or encumbrance accounting procedures (816). Because budgetary controls and/or encumbrance accounting require that purchase costs be set aside immediately against an organization's budget, these allocations need to use the most up-to-date information from the purchase order distributions. When a purchase order is canceled, the canceled distributions will be de-allocated in the organization's budget. When the requisition lines are reinstated, any mismatch between the canceled amount and the new amount will result in a budget shortfall or increase, based on circumstance.

Therefore, the methods described herein may move funds from obligation to commitment for budgetary controls and/or encumbrance accounting systems. The funds moved for each distribution may often be equivalent to the canceled amount determined for each purchase order distribution identified by this method. The budget can be determined from the billing information, and more specifically by the charge account on the purchase order distribution that was canceled.

It should be appreciated that the specific steps illustrated in FIGS. 7-8 provide particular methods of reinstating canceled purchase order distributions according to various embodiments of the present invention. Other sequences of steps may also be performed according to alternative embodiments. For example, alternative embodiments of the present invention may perform the steps outlined above in a different order. Moreover, the individual steps illustrated in FIGS. 7-8 may include multiple sub-steps that may be performed in various sequences as appropriate to the individual step. Furthermore, additional steps may be added or removed depending on the particular applications. One of ordinary skill in the art would recognize many variations, modifications, and alternatives.

Additionally, it will be understood that each item represented by the flowcharts herein may be implemented using an electronic database record. Therefore, a purchase order or canceled purchase order may be implemented using an electronic representation of a purchase order. Additionally, purchase order distributions may be represented by purchase order distribution records, requisition distributions may be represented by requisition distribution records, requisition lines may be represented by requisition line records, and so forth.

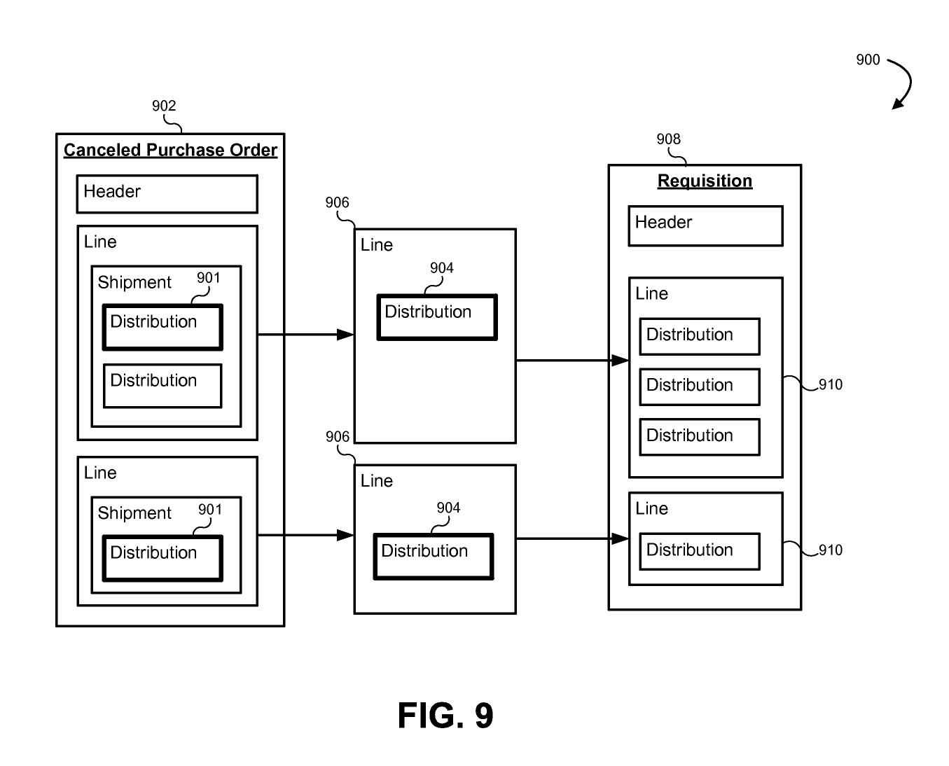

FIG. 9 illustrates a block diagram 900 for updating a requisition 908 from a canceled purchase order 902, according to some embodiments. The example of FIG. 9 may follow one or more of the steps illustrated in flowchart 700 and/or flowchart 800. Purchase order 902 may be canceled, and certain distributions 901 within the canceled purchase order 902 may still be unfulfilled. These distributions 901 may be identified and used to create new requisition distributions 904. These new distributions 904 may copy information over from the canceled purchase order distributions 901, including quantity and/or pricing information. New requisition lines 906 may be created to encapsulate the new requisition distributions 904. References in the distributions 901 and/or lines of the canceled purchase order 902 may be used to identify distributions and/or lines 910 in the original requisition 908. Line information from the purchase order lines in the canceled purchase order 902 and/or the requisition lines 910 in the requisition 908 may be used to complete the requisition line information for the new requisition lines 906. It should be noted that although the new distributions 904 each have new requisition lines 906, and both requisition lines 906 related to the same requisition 908, this need not always be the case. For example, each of the new requisition distributions 904 may be related to the same original requisition line, and/or each of the new requisition lines 906 may be related to different requisitions.

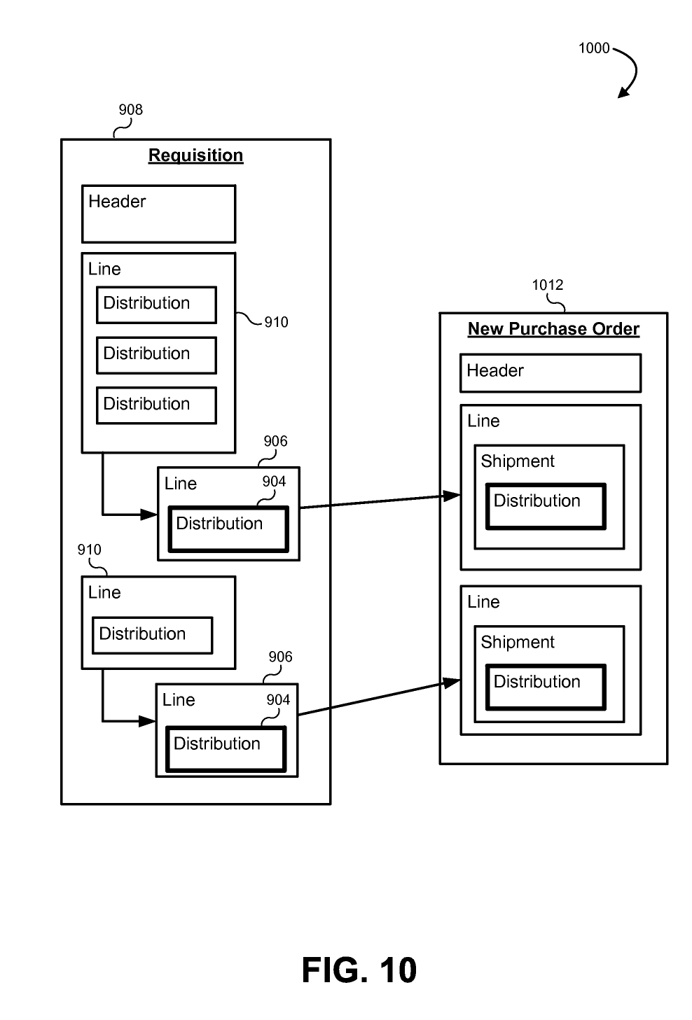

FIG. 10 illustrates a block diagram 1000 for creating a new purchase order from a requisition, according to some embodiments. Continuing from block diagram 900 of FIG. 9, the new requisition lines 904 may be added as children to the existing requisition lines 910 in the original requisition 908. The requisition 908 may then be sent to the purchasing department and transformed into a new purchase order 1012. The computer system of the purchasing department may automatically recognize that requisition 908 includes child lines from a canceled purchase order. The computer system of the purchasing department may then disregard the original requisition lines 910 and process only the new requisition lines 904 to generate the new purchase order 1012. This prevents duplicating orders that were not canceled in an original purchase order. The new purchase order 1012 can allocate new shipments with the purchase order distributions according to the purchasing department's cost-saving protocols.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

1. A method of reinstating electronic requisition demands using information from an electronic representation of a canceled purchase order in an enterprise accounting computer system, the method comprising:
identifying, using a computer system, canceled purchase order distribution records in the electronic representation of the canceled purchase order by identifying purchase order distribution records in the canceled purchase order that are unfulfilled;
generating, using the computer system, new requisition distribution records by performing operations comprising: copying distribution information from the canceled purchase order distribution records into the new requisition distribution records;
generating, using the computer system, new requisition line records based on the new requisition distribution records; and
generating, using the computer system, an electronic representation of one or more new purchase orders based on the new requisition line records.

2. The method of claim 1 wherein, when generating the new requisition distribution records, the operations further comprise copying information from original requisition line records into the new requisition line records.

3. The method of claim 2 wherein the information from the original requisition line records comprises a designation of a product or service being purchased.

4. The method of claim 1 wherein generating the new requisition distribution records based on the canceled purchase order distribution records comprises:
copying billing and delivery information from the canceled purchase order distribution records to the new requisition distribution records.

5. The method of claim 1 further comprising computing new requisition quantities for the new requisition distribution records based on canceled distribution quantities in the canceled purchase order distribution records.

6. The method of claim 1 further comprising computing new requisition costs for the new requisition distribution records based on canceled distribution costs in the canceled purchase order distribution records.

7. The method of claim 1 wherein identifying canceled purchase order distribution records in the electronic representation of the canceled purchase order comprises:
identifying canceled purchase order distribution records that have not been invoiced.

8. The method of claim 1 wherein the canceled purchase order distribution records have changed since the electronic representation of the canceled purchase order was generated such that the canceled purchase order distribution records are not the same as original requisition distribution records.

9. The method of claim 1 further comprising inserting the new requisition line records into an original requisition record.

10. The method of claim 9 wherein the new requisition line records are inserted into the original requisition record as children of corresponding original requisition line records.

11. A computer-readable memory comprising a sequence of instructions which, when executed by one or more processors, causes the one or more processors to reinstate electronic requisition demands using information from an electronic representation of a canceled purchase order in an enterprise accounting computer system by:
identifying canceled purchase order distribution records in the electronic representation of the canceled purchase order by identifying purchase order distribution records in the canceled purchase order that are unfulfilled;
generating new requisition distribution records by performing operations comprising: copying distribution information from the canceled purchase order distribution records into the new requisition distribution records;
generating new requisition line records based on the new requisition distribution records; and
generating an electronic representation of one or more new purchase orders based on the new requisition line records.

12. The computer-readable memory according to claim 11 wherein, when generating the new requisition distribution records, the operations further comprise copying information from original requisition lines into the new requisition lines.

13. The computer-readable memory according to claim 11 wherein generating the new requisition distribution records based on the canceled purchase order distribution records comprises:
copying billing and delivery information from the canceled purchase order distribution records to the new requisition distribution records.

14. The computer-readable memory according to claim 11 wherein the instructions further cause the one or more processors to reinstate electronic requisition demands using information from an electronic representation of a canceled purchase order in an enterprise accounting computer system by:
computing new requisition quantities for the new requisition distribution records based on canceled distribution quantities in the canceled purchase order distribution records.

15. The computer-readable memory according to claim 11 wherein the instructions further cause the one or more processors to reinstate electronic requisition demands using information from an electronic representation of a canceled purchase order in an enterprise accounting computer system by:
computing new requisition costs for the new requisition distribution records based on canceled distribution costs in the canceled purchase order distribution records.

16. The computer-readable memory according to claim 11 wherein the canceled purchase order distribution records have changed since the electronic representation of the canceled purchase order was generated such that the canceled purchase order distribution records are not the same as original requisition distribution records.

17. A system comprising:
one or more processors; and
a memory communicatively coupled with and readable by the one or more processors and comprising a sequence of instructions which, when executed by the one or more processors, cause the one or more processors to reinstate electronic requisition demands using information from an electronic representation of a canceled purchase order in an enterprise accounting computer system by:
identifying canceled purchase order distribution records in the electronic representation of the canceled purchase order by identifying purchase order distribution records in the canceled purchase order that are unfulfilled;
generating new requisition distribution records by performing operations comprising: copying distribution information from the canceled purchase order distribution records into the new requisition distribution records;
generating new requisition line records based on the new requisition distribution records; and
generating an electronic representation of one or more new purchase orders based on the new requisition line records.

18. The system of claim 17 wherein, when generating the new requisition distribution records, the operations further comprise copying information from original requisition line records into the new requisition line records.

19. The system of claim 17 wherein generating the new requisition distributions based on the canceled purchase order distributions comprises:
copying billing and delivery information from the canceled purchase order distribution records to the new requisition distribution records.

20. The system of claim 17 wherein the canceled purchase order distribution records have changed since the electronic representation of the canceled purchase order was generated such that the canceled purchase order distribution records are not the same as original requisition distribution records.
